(19) United States
(12) Patent Application Publication
(10) Pub. No.: US 2025/0371593 A1
(43) Pub. Date: Dec. 4, 2025

(54) METHODS AND APPARATUS TO PROVIDE A QUOTATION FOR METAL USING MACHINE LEARNING MODEL(S)

(71) Applicant: Ryerson Procurement Corporation, Chicago, IL (US)

(72) Inventors: Edward J. Lehner, Shaker Heights, OH (US); Alagu Sundarrajan, Houston, TX (US); Trent M. McFarland, Stillwater, MN (US); Frank C. Williams, Glen Ellyn, IL (US); Thomas B. Masterson, Downers Grove, IL (US); Alexandre Fernandes, Middleton, WI (US); Roberto Stentella, Naperville, IL (US); Donald D. Fleschut, Naperville, IL (US)

(21) Appl. No.: 19/228,204

(22) Filed: Jun. 4, 2025

Related U.S. Application Data
(60) Provisional application No. 63/655,959, filed on Jun. 4, 2024.

(51) Int. Cl. G06Q 30/0601

(52) U.S. Cl. CPC G06Q 30/0611; G06Q 30/0621; G06Q 30/0641

(57) ABSTRACT

Systems, apparatus, articles of manufacture, and methods to provide a quotation for metal using machine learning model(s) are disclosed. An example machine readable storage medium comprises instructions to cause programmable circuitry to access a request from a customer for a quotation, create a data structure identifying at least one item included in the request, use a machine learning model to identify at least one attribute of the at least one item based on the data structure, select a product identifier based on the at least one attribute, generate a request summary using the product identifier, and prepare the quotation to be provided to the customer.

### RELATED APPLICATION

This patent claims the benefit of U.S. Provisional Patent Application No. 63/655,959, which was filed on Jun. 4, 2024. U.S. Provisional Patent Application No. 63/655,959 is hereby incorporated herein by reference in its entirety. Priority to U.S. Provisional Patent Application No. 63/655,959 is hereby claimed.

### FIELD OF THE DISCLOSURE

This disclosure relates generally to providing quotations and, more particularly, to methods and apparatus to provide a quotation for metal using machine learning model(s).

### BACKGROUND

In the highly competitive metal industry, suppliers often receive numerous requests for quotations (RFQs) from customers seeking various types of metal products or services. These RFQs can be complex, containing detailed specifications and requirements that need to be accurately interpreted by sales representatives in order to provide timely and accurate responses. Misunderstandings or delays in responding to these requests may result in lost business opportunities for the supplier.

### BRIEF DESCRIPTION OF THE DRAWINGS

FIG. 1 is a block diagram of an example environment in which an example supplier operates to provide a quotation using machine learning models(s).

FIG. 2 is a block diagram of an example implementation of the request interpreter circuitry of FIG. 1.

FIG. 3 is a diagram illustrating a flow of data through the request interpreter circuitry of FIGS. 1 and/or 2.

FIG. 4 is a diagram representing identification of an attachment to a request for quotation for processing.

FIG. 5 is a diagram representing interpretation of a request for quotation into a textual format.

FIG. 6A is a diagram representing different specially trained machine learning models that may be used to detect corresponding attributes of an item included in a request for quotation.

FIG. 6B is a diagram representing different generative machine learning models that may be used to detect corresponding attributes of an item included in a request for quotation.

FIG. 7 is a diagram representing lookup of a stock keeping unit (SKU) based on detected attributes of an item identified in the request for quotation.

FIG. 8 is an example quotation review user interface that may be presented to a sales representative.

FIGS. 9A, 9B, and 9C are a flowchart representative of example machine readable instructions and/or example operations that may be executed, instantiated, and/or performed by example programmable circuitry to implement the request interpreter circuitry 130 of FIG. 1 to interpret a request for quotation and prepare a request summary based thereon.

FIG. 10 is a flowchart representative of example machine readable instructions and/or example operations that may be executed, instantiated, and/or performed by example programmable circuitry to implement the quotation generator circuitry 140 of FIG. 1 to prepare a quotation based on the request summary.

FIG. 11 is a block diagram of an example processing platform including programmable circuitry structured to execute, instantiate, and/or perform the example machine readable instructions and/or perform the example operations of FIGS. 9A, 9B, 9C, and/or 10 to implement the supplier infrastructure 118 of FIG. 1.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine readable instructions of FIGS. 9A, 9B, 9C, and/or 10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

There is a growing demand for efficient systems and processes that can help suppliers quickly interpret requests for quotations (RFQs_ received from customers, identify relevant products, and generate accurate quotations without sacrificing quality or accuracy. This not only benefits the metal industry but also has broader applications across various industries where timely and accurate responses to customer requests are crucial.

Examples disclosed herein utilize machine learning techniques for interpreting customer requests, identifying relevant products, and generating accurate quotations. The system begins by receiving a request from a customer (e.g., via email) which is then interpreted using request interpreter circuitry that employs machine learning algorithms to identify key attributes of the requested product. The request interpreter circuitry first determines whether the received message (e.g., the email) is truly a quote or order request. If the received message is not a quote or order request, the email is discarded. If the received message is a quote or order request, the request interpreter continues to extract the “metal language” data from the communication (e.g., the key attributes of the requested product). A product database containing information on available products is accessed based on these detected attributes to identify a corresponding product (e.g., as identified by a stock keeping unit (SKU)). Ideally, an identical matching product is identified based on the attributes. However, in some examples, multiple corresponding products might be identified and ranked based on, for example, similarity to the key attributes, product availability, geographic proximity to the customer, past customer purchases, etc. Such ranking might be presented to a sales representative to enable selection and/or confirmation of the identified product. Once all relevant items of the customer request have been identified, a quotation is generated using quotation generator circuitry. If any modifications are needed to the quotation (e.g., adjusting prices, selecting a different product, etc.), such modifications can be applied before providing access to the final quote to the customer. In some examples, this quotation may be provided directly to the customer. Such an approach enables suppliers to respond more accurately and in a timely manner to customer requests for quotations.

Further still, in some examples, beyond providing the quotation to the customer, examples disclosed herein may place an order on behalf of the customer. In some examples, the order might first be validated or reviewed by a customer service representative. In other words, examples disclosed herein might process an order based on the initial request from the customer, without having to request that the customer review and/or approve of a quotation.

Example approaches disclosed herein are capable of handling many different types of input requests as received from a customer including, for example, textual requests (e.g., a request included in a body of an email) may be received. In some examples, request information may be attached to the communication such as, for example, a hand-written request included in an image attached to an email, an in-line image within an email, an attached Microsoft Excel document (e.g., .XLS or .XLSX), an attached portable document format (.PDF) document, a Microsoft Word document (e.g., .DOC, .DOCX), and/or other types of requests.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, multiple different types of machine learning models are utilized to enable detection of various types of attributes of items. For example, utilizing a classifier model enables detection of attributes that may have a limited number of potential selections (e.g., there may be only a few different types of finishes available for a particular type of product). In contrast, large language models may be utilized as they enable human-like recognition, standardization, and/or organization of information (e.g., to create an understanding of dimension attributes). In general, machine learning models/architectures that are suitable to use in the example approaches disclosed herein will be approaches that enable accurate detection of product attributes in an efficient manner. However, other types of machine learning models could additionally or alternatively be used such as neural networks (NNs), support vector machines (SVMs), Long Short Term Memory (LSTM), Gated Recurrent Unit (GRU), Generative Pre-Trained Transformer (GPT), etc.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using stochastic gradient descent. However, any other training algorithm may additionally or alternatively be used. In examples disclosed herein, training is performed until an acceptable amount of error is achieved among a test data set. In examples disclosed herein, training is performed at computing equipment operated by a supplier. However, training may be performed in any other location including, for example, a cloud server location. Training is performed using hyperparameters that control how the learning is performed (e.g., a learning rate, a number of layers to be used in the machine learning model, etc.). In some examples, re-training may be performed. Such re-training may be performed in response to modifications and/or mis-identifications of products as identified by a sales representative, new attributes, etc.

Training is performed using training data. In examples disclosed herein, the training data originates from prior customer communications (e.g., customer emails, requests for quotation, etc.) and/or information extracted therefrom. In some examples, multiple different models (perhaps having different model architectures and/or types) may be trained, perhaps based on different customer communications information and/or different information extracted from such customer communications information. Such training may be performed utilizing supervised training, where a corresponding model is trained to produce a desired output based on a given (e.g., known) input. Because supervised training is used, the training data may be considered to be labeled. Labeling is applied to the training data by applying classifications to existing training data. For example, prior customer communications and/or items identified therein may be used to identify the attributes of the items included in the communications, and be used in association with original customer communications (e.g., an email request provided by a customer). In some examples, the training data is pre-processed using, for example, optical character recognition, to enable image data (e.g., a scan of a handwritten customer order) to be utilized as part of the training.

Once training is complete, the model(s) are deployed for use as an executable construct that processes an input and provides an output based on the network of nodes and connections defined in the model. The model is stored at a server operated by a supplier. The model may then be executed by the server and/or other circuitry operated by the supplier. However, in some examples, the model may be stored at a third party server (e.g., a cloud server) and/or may be operated by a third party (e.g., a cloud services provider).

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

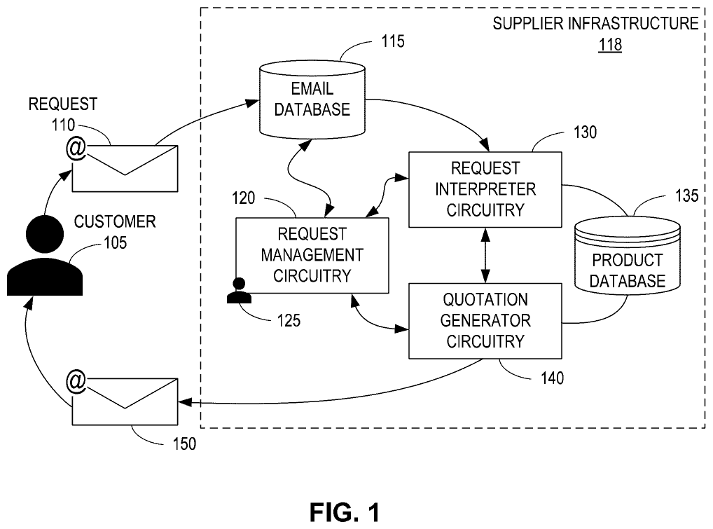

FIG. 1 is a block diagram of an example environment in which an example supplier operates to provide a quotation using machine learning models(s). In the illustrated example of FIG. 1, a customer 105 provides a request 110 to a supplier infrastructure 118. The supplier infrastructure 118 processes the request to provide a quotation 150.

The supplier infrastructure 118 of the illustrated example of FIG. 1 includes an email database 115, request management circuitry 120 which is operated by and/or utilized by a sales representative 125, request interpreter circuitry 130, a product database 135, and quotation generator circuitry 140.

The example customer 105 of the illustrated example of FIG. 1 is an entity that requests products or services from the supplier. This could be an individual consumer, a business, or any other organization requiring goods and/or services. The customer 105 communicates their requirements to the supplier through various channels such as email, phone calls, or online forms.

The example request 110 of the illustrated example of FIG. 1 is a communication containing information about what products or services the customer 105 is requesting from the supplier infrastructure 118. As noted above, this could be in the form of an order form, a detailed description of the required product/service, or even just a simple email asking for a quotation. In some examples, the request is not detailed in writing (e.g., specifics of a requested product might not be provided), but such details may be inferred and/or implied based on what a sales representative might know about the customer and their requirements. In some examples, the models utilized by the example request interpreter circuitry 130 may be trained with these requirements in mind. In some examples, additional content (e.g., an attachment) included with the email might include the actual request (e.g., a scan of an order request form as an image or a portable document format (PDF) file).

The example email database 115 of the illustrated example of FIG. 1 represents an electronic storage system (e.g., an email server) that stores emails received by the supplier infrastructure 118. The example email database 115 allows the sales representative to access and review previous communications with the customer 105, and select emails and/or other communications that are to be processed by the request interpreter circuitry 130 for identification of information for preparation of a quote.

The example request management circuitry 120 represents a platform with which the sales representative 125 may use to interact with the email database 115 and select items to be provided to the request interpreter circuitry 130. In some examples, the request management circuitry 120 may be implemented using an email application, a website, a plug-in to an email application, etc. In some examples, the request management interface 210 enables the sales representative to tag and/or otherwise identify customer communications for analysis by the request interpreter circuitry 130. Such tagging may be applied to communications stored in the email database 115, and/or may be provided directly to the request interpreter circuitry 130. Tagging an email in the email database 115 enables the request interpreter circuitry 130 to periodically (and/or a-periodically) search the email database 115 for communications to be analyzed (e.g., tagged communications that have not yet been processed). In some examples, an item may be analyzed to enable automatic tagging analysis by the request interpreter circuitry 130.

The sales representative 125 of the illustrated example of FIG. 1 is an employee and/or associate of the supplier infrastructure 118 who interacts with customers 105 and manages the requests. In this manner, the sales representative 125 understands the preferences and/or expectations of the customer 105, and applies such understanding when reviewing the quotations generated by the quotation generator circuitry 140.

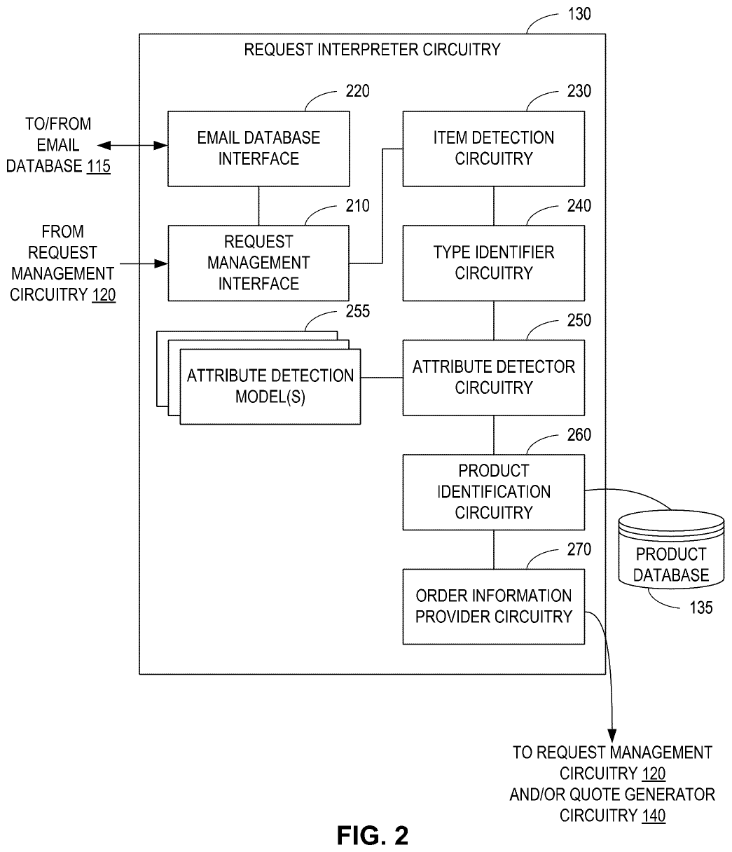

The example request interpreter circuitry 130 of the illustrated example of FIG. 1 interprets requests provided by the customer 105 to generate a request summary that is used by the quotation generator 140 to generate a quote. Further explanation of components of the request interpreter circuitry 130 are described below in connection with FIG. 2. In short, the example request interpreter circuitry 130 may be implemented using one or more server systems, which may be implemented locally to the supplier infrastructure 118 (e.g., within a computing environment hosted by the supplier infrastructure 118), or implemented at a third party computing system (e.g., a cloud service provider).

The example product database 135 of the illustrated example of FIG. 1 represents a database and/or other data structure that stores information about products offered by the supplier infrastructure 118. This includes details such as product specifications, pricing, availability, locations, etc. Sales representatives can use this product database 135 to quickly look up relevant product information when preparing a quotation for the customer request 110. In examples disclosed herein, the example request interpreter circuitry 130 and/or the example quotation generator circuitry 140 utilize the product database 135 when identifying products and/or preparing quotations. In some examples, other information besides product information is stored in the product database 135 including, for example, customer information. Such customer information enables the example request interpreter circuitry 130 to prepare accurate request summaries (e.g., based on prior customer requests and/or orders), and/or enables the example quotation generator circuitry 140 to prepare accurate quotations based on such customer information.

The example quotation generator circuitry 140 of the illustrated example of FIG. 1 generates quotations based on the interpreted customer request and the available products in the supplier inventory (e.g., based on information in the product database 135). The example quotation generator circuitry 140 takes into account factors such as pricing, availability, and any special requirements specified by the customer to create an accurate and tailored quotation. In examples disclosed herein, a preliminary (e.g., sample) quotation is provided to the sales representative 125 to enable the sales representative to make modifications to the quotation if necessary prior to the quotation 150 being provided to the customer 105.

In the illustrated example of FIG. 1, the example quotation 150 (e.g., once approved by the sales representative 125) may be provided to the customer 105 by the quotation generator circuitry 140. In some examples, this quotation is provided to the customer 105 in an email format. In other examples, a link to a web interface provided by the quotation generator circuitry 140 is provided to the customer 105. In some examples, a customer may have an account with the supplier and may be able to access their quotes via a web interface using such an account (e.g., quotations generated in association with the customer).

FIG. 2 is a block diagram of an example implementation of the request interpreter circuitry 130 of FIG. 1 to interpret a customer request. The request interpreter circuitry 130 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the request interpreter circuitry 130 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example email database interface 220 of the illustrated example of FIG. 2 enables communication between the request interpreter circuitry 130 and the email database 115. For example, the email database interface 220 allows the request interpreter circuitry 130 to access customer emails containing requests, ensuring that the request interpreter circuitry 130 has access to all relevant information for accurate interpretation. In some examples, instead of utilizing the example email database interface 220 to access the email database 115, the content of the customer request(s) is provided directly to the request management interface 210.

The example request management interface 210 of the illustrated example of FIG. 2 facilitates communication between the request interpreter circuitry 130 and the request management circuitry 120. This enables the request interpreter circuitry 130 to receive customer requests at the direction of the sales representative 125. Via this interface, the sales representative 125 may track the progress of their customer requests, coordinate with other systems within the supplier's infrastructure, etc.

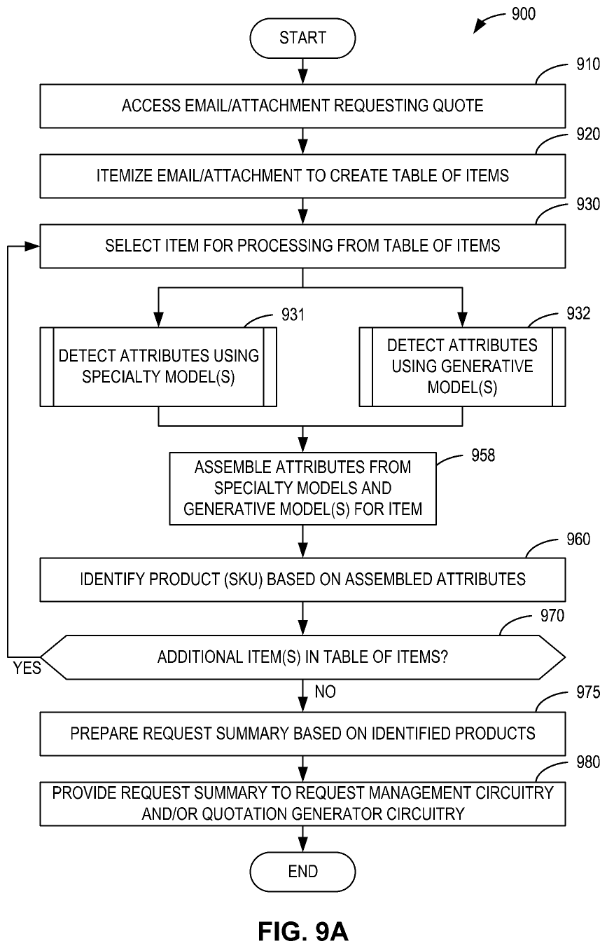

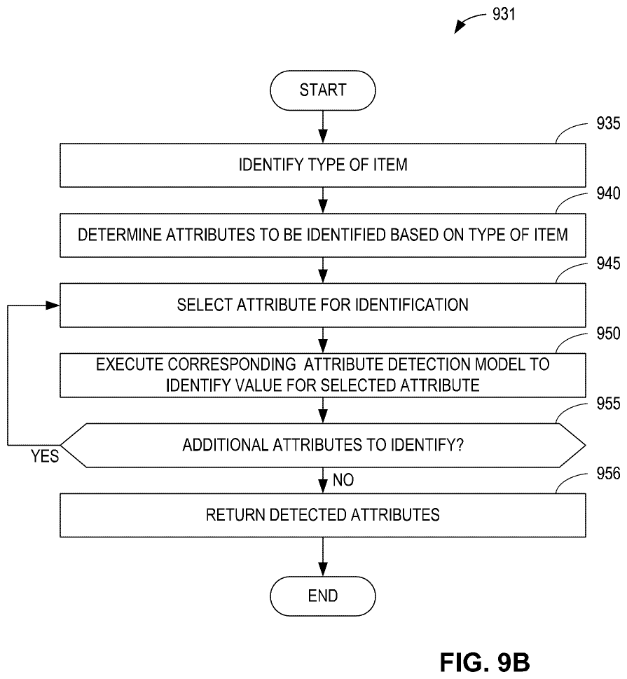

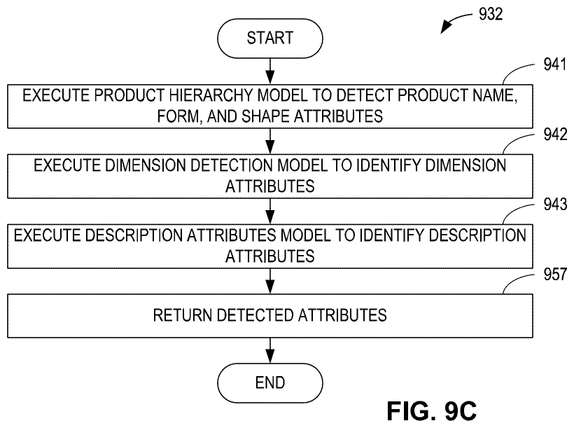

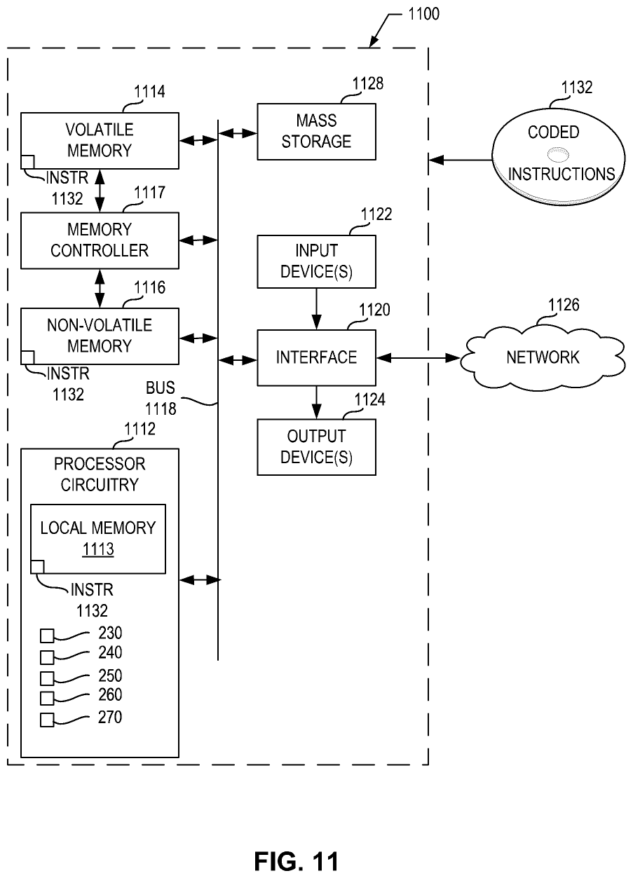

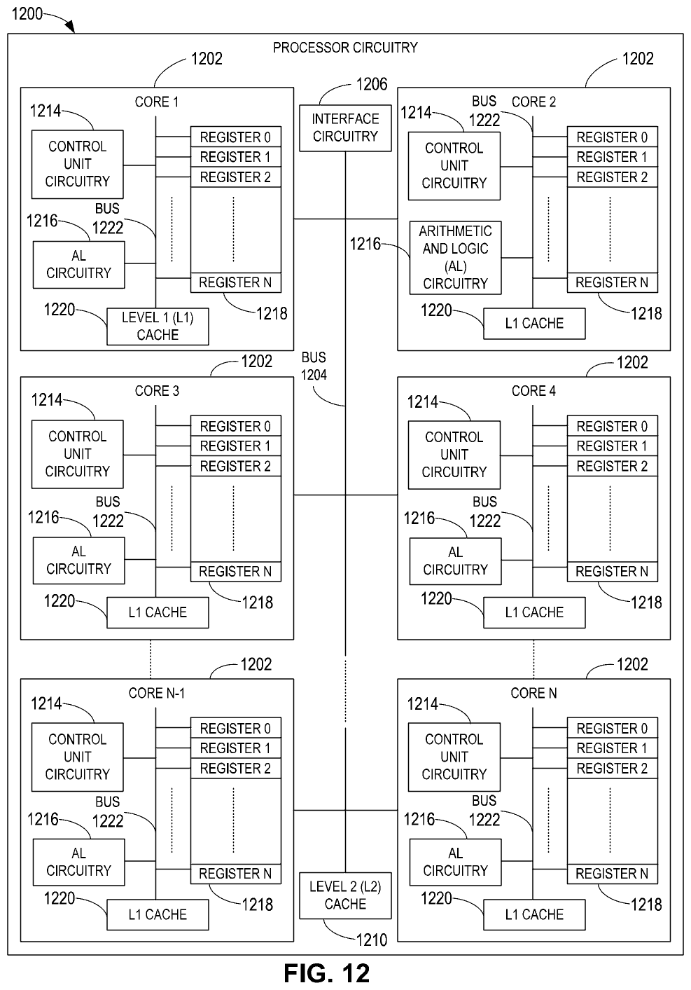

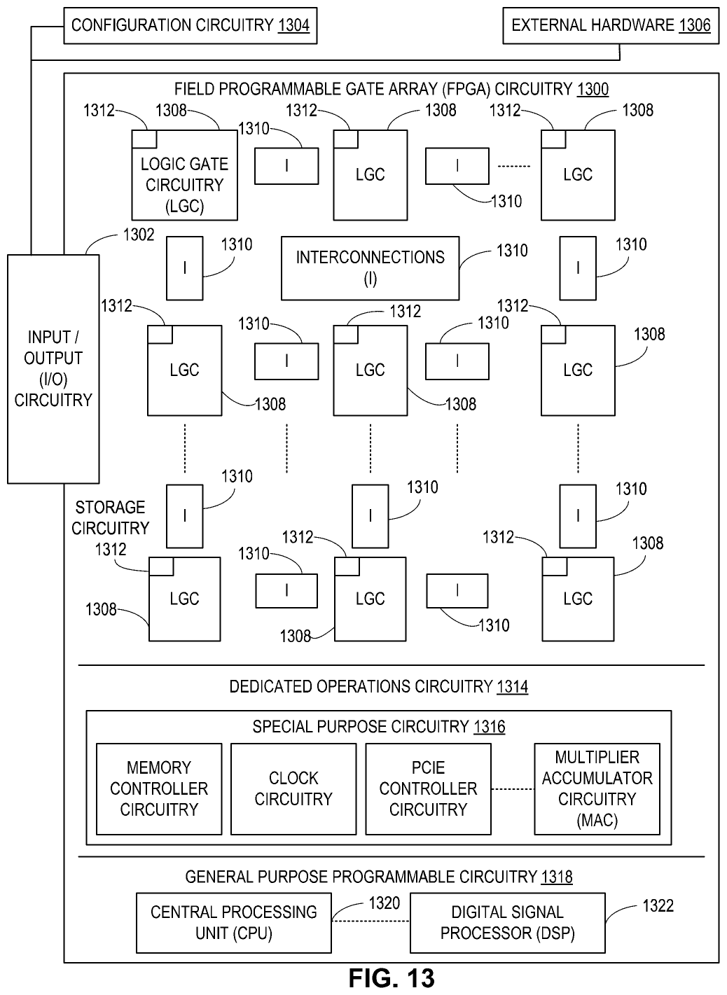

In some examples, the request management interface 210 is instantiated by programmable circuitry executing request management instructions and/or configured to perform operations such as those represented by the flowchart(s) of FIGS. 9A, 9B, and 9C. In some examples, the request interpreter circuitry 130 includes means for receiving a request. For example, the means for receiving a request may be implemented by request management interface 210. In some examples, the request management interface 210 may be instantiated by programmable circuitry such as the example programmable circuitry 1112 of FIG. 11. For instance, the request management interface 210 may be instantiated by the example microprocessor 1200 of FIG. 12 executing machine executable instructions such as those implemented by at least block 910 of FIGS. 9A, 9B, and 9C. In some examples, the request management interface 210 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the request management interface 210 may be instantiated by any other combination of hardware, software, and/or firmware. For example, the request management interface 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

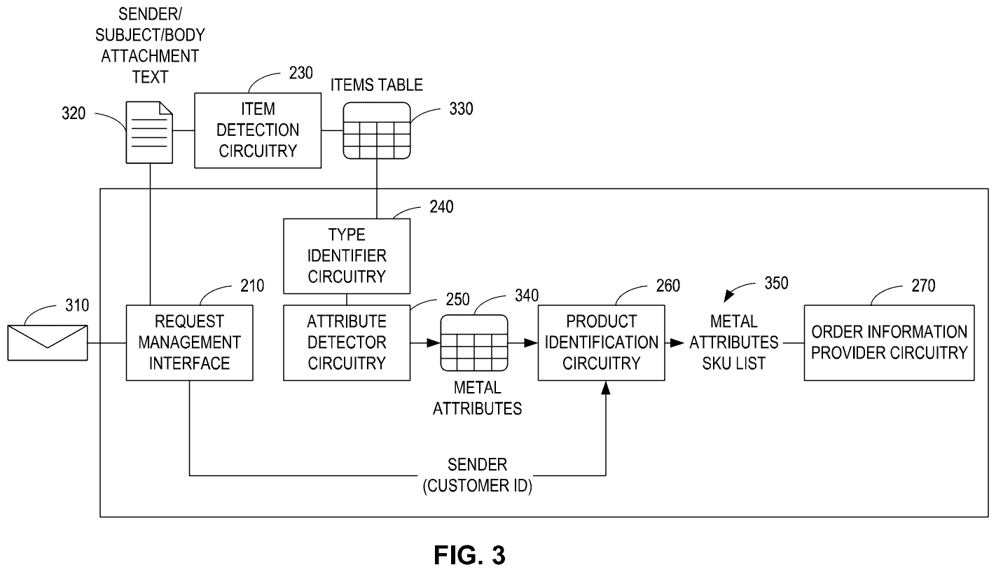

The example item detection circuitry 230 of the illustrated example of FIG. 2 itemizes components of the customer request to form a table of items. The table of items, which is described in further detail in FIG. 3, includes a description of the item, a quantity, and a unit of measure. The example item detection circuitry 230 may utilize form recognition techniques and/or optical character recognition techniques to parse the customer request and construct the table of items.

In some examples, the item detection circuitry 230 is instantiated by programmable circuitry executing item detection instructions and/or configured to perform operations such as those represented by the flowchart(s) of FIGS. 9A, 9B, and 9C. In some examples, the request interpreter circuitry 130 includes means for itemizing a request. For example, the means for itemizing a request may be implemented by item detection circuitry 230. In some examples, the item detection circuitry 230 may be instantiated by programmable circuitry such as the example programmable circuitry 1112 of FIG. 11. For instance, the item detection circuitry 230 may be instantiated by the example microprocessor 1200 of FIG. 12 executing machine executable instructions such as those implemented by at least blocks 920 and 930 of FIGS. 9A, 9B, and 9C. In some examples, item detection circuitry 230 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the item detection circuitry 230 may be instantiated by any other combination of hardware, software, and/or firmware. For example, the item detection circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example type identifier circuitry 240 identifies a type of each item included in the table of items created by the item detection circuitry 230. Once items have been detected in the customer request, the example type identifier circuitry 240 circuitry determines what type of product is being referred to by the customer. In examples disclosed herein, a form and/or shape detection model (e.g., one of the attribute detection models) is executed to detect the form and shape of the item. In combination, the form and shape may be referred to as the type of the item. However, other attributes may also be considered as part of the type of the item. Identifying the type of the item enables the attribute detector circuitry 250 to select appropriate attribute detection model(s) 255 for execution.

In some examples, the type identifier circuitry 240 is instantiated by programmable circuitry executing type identifier instructions and/or configured to perform operations such as those represented by the flowchart(s) of FIGS. 9A, 9B, and 9C. In some examples, the request interpreter circuitry 130 includes means for identifying a type of an item. For example, the means for identifying a type of an item may be implemented by type identifier circuitry 240. In some examples, the type identifier circuitry 240 may be instantiated by programmable circuitry such as the example programmable circuitry 1112 of FIG. 11. For instance, the type identifier circuitry 240 may be instantiated by the example microprocessor 1200 of FIG. 12 executing machine executable instructions such as those implemented by at least block 935 of FIGS. 9A, 9B, and 9C. In some examples, the type identifier circuitry 240 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the type identifier circuitry 240 may be instantiated by any other combination of hardware, software, and/or firmware. For example, the type identifier circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The attribute detector circuitry 250 of the illustrated example of FIG. 2 selects and executes (or causes execution of) one or more of the attribute detection model(s) 255. In examples disclosed herein, the attribute detector circuitry 250 selects the attribute detection model(s) based on the type of the item, as identified by the type identifier circuitry 240. In some examples, the attribute detector circuitry 250 parses responses and/or results from the attribute detection model(s) 255 to determine a value for a given attribute of an item.

In some examples, the attribute detector circuitry 250 selects attribute detection model(s) for execution regardless of the type of item. For example, one or more generative models might be utilized to detect attributes of the item, as opposed to the selection of specific attribute detection model(s) that are purpose-trained for identifying particular attributes.

In some examples, both generative models and purpose-trained models might be utilized. The results of those detected attributes may then be aggregated for identification of an SKU of the associated product. In some examples, attributes identified via generative models might be preferred over attributes identified via purpose-trained models. Such preference might be the result of the generative model(s) being more adaptive to various permutations of how a customer might annotate the attributes of the desired product in their request. However, purpose-trained models might be preferred in some instances when the recognition quality of the generative model(s) is low (e.g., when there is a low confidence in detection of a particular attribute by a generative model), or no result is returned for a particular attribute.

In some examples, the attribute detector circuitry 250 is instantiated by programmable circuitry executing attribute detection instructions and/or configured to perform operations such as those represented by the flowchart(s) of FIGS. 9A, 9B, and 9C.

In some examples, the request interpreter circuitry 130 includes means for determining an attribute for an item. For example, the means for determining may be implemented by attribute detector circuitry 250. In some examples, the attribute detector circuitry 250 may be instantiated by programmable circuitry such as the example programmable circuitry 1112 of FIG. 11. For instance, the attribute detector circuitry 250 may be instantiated by the example microprocessor 1200 of FIG. 12 executing machine executable instructions such as those implemented by at least blocks 931, 932, 940, 941, 942, 943, 945, 950, 955, 956, and 957 of FIGS. 9A, 9B, and 9C. In some examples, the attribute detector circuitry 250 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the attribute detector circuitry 250 may be instantiated by any other combination of hardware, software, and/or firmware. For example, the attribute detector circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example attribute detection model(s) 255 of the illustrated example of FIG. 2 are machine learning model(s) that may be executed using an input (e.g., a textual description of an item) to determine one or more attributes. In some examples, the attribute detection model(s) 255 are executed by the attribute detector circuitry 250 locally within the supplier infrastructure 118. In some examples, the attribute detection model(s) 255 are executed at a third-party platform (e.g., a cloud services provider), and the results of such execution are provided to the attribute detector circuitry 250.

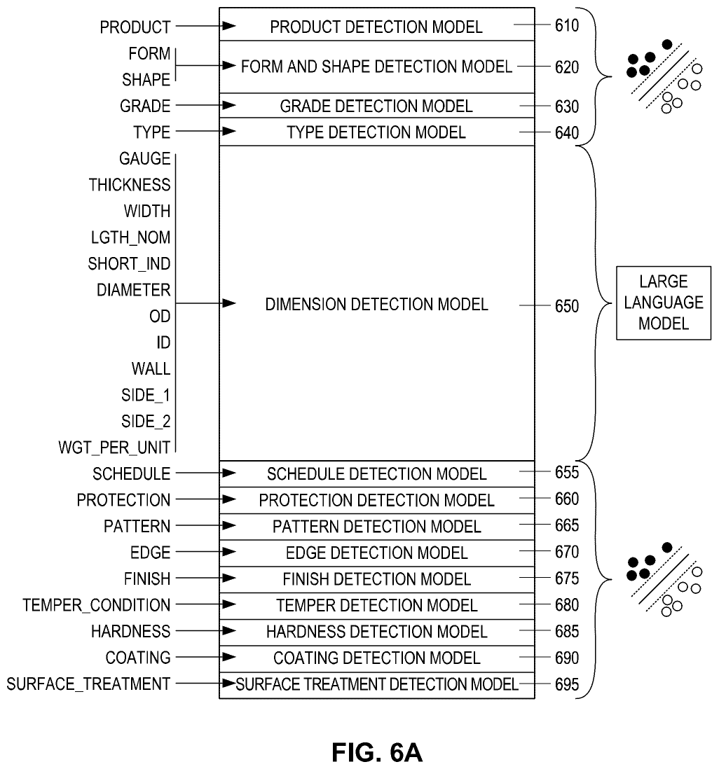

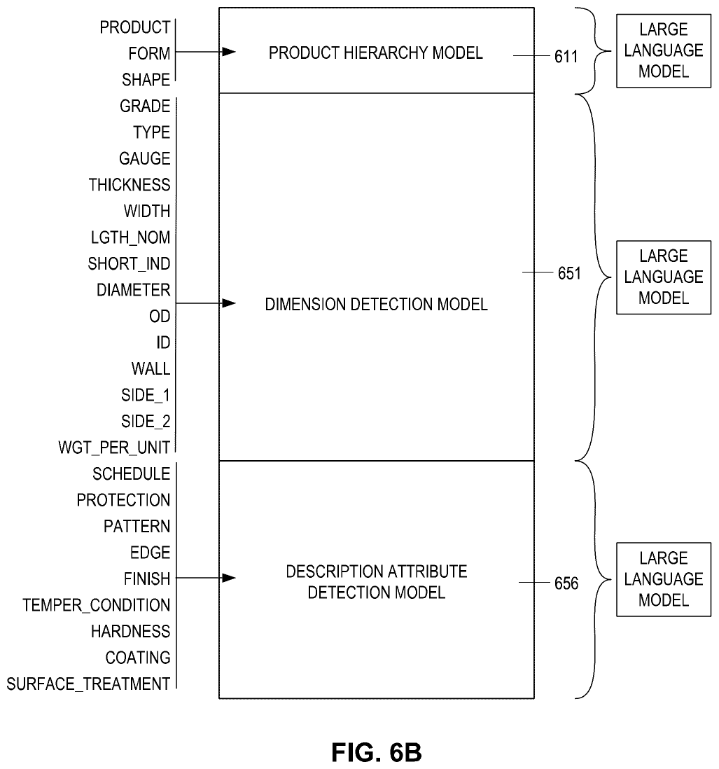

Example attribute detection model(s) are disclosed in further detail in connection with FIGS. 6A and 6B. In short, different types of attribute detection models may be used and may be selected based on their ability to accurately determine a desired output. For example, classifier models may be utilized when the attribute may be one of a few select values (e.g., a classifier may be used to identify a surface finish attribute and may classify between selections of: no finish, electroplated, bead blasted, anodized, electroless plating, powder coated, phosphate coated, electropolished, buff polished, abrasive blasted, etc.). In contrast, large language models might be utilized when the input must be more flexible than a select few values. For example, a large language model may be better at detecting requested dimensions for the item, when such dimensions might not necessarily conform to the products that are readily available by the supplier (e.g., requesting sheet metal goods that are two and a half feet in length, when lengths are provided in increments of one foot). In some examples, large language models (e.g., generative models) might also be used for detection of attributes that would otherwise be identified by a classifier model (e.g., a purpose-trained model). Generative models might be used in such examples because they are more resilient to variations in input data formats that were not included as part of the training of the purpose-trained model.

The example product identification circuitry 260 of the illustrated example of FIG. 2 uses attributes identified by the attribute detector circuitry 250 to identify a product identifier within the product database 135. In some examples, the product identification circuitry 260 prepares one or more structured query language (SQL) queries to determine an appropriate product identifier (e.g., a stock keeping unit (SKU)) for a product in the product database. In some examples, product dimensions may be increased form customer requirements to identify an appropriate product for selection. For example, if a customer requested tubular steel having a length of two and a half feet, but such tubular steel products are available in one foot increments, the example product identification circuitry 260 may select a tubular steel product that is three feet in length, so as to meet the customer requirements (as tubular steel two feet in length would not meet the customer requirements). In some examples, the report that is generated by order information provider circuitry 270 may include a warning and/or other information to identify to the sales representative 125 when a selected product deviates from the customer request.

In some examples, the product identification circuitry 260 is instantiated by programmable circuitry executing product identification instructions and/or configured to perform operations such as those represented by the flowchart(s) of FIGS. 9A, 9B, and 9C.

In some examples, the request interpreter circuitry 130 includes means for identifying a product. For example, the means for identifying a product may be implemented by product identification circuitry 260. In some examples, the product identification circuitry 260 may be instantiated by programmable circuitry such as the example programmable circuitry 1112 of FIG. 11. For instance, the product identification circuitry 260 may be instantiated by the example microprocessor 1200 of FIG. 12 executing machine executable instructions such as those implemented by at least blocks 960 and 970 of FIGS. 9A, 9B, and 9C. In some examples, product identification circuitry 260 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the product identification circuitry 260 may be instantiated by any other combination of hardware, software, and/or firmware. For example, the product identification circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example order information provider circuitry 270 prepares a request summary based on the products identified by the request interpreter circuitry. In examples disclosed herein, the request summary identifies products, quantities, units of measurement, customer information, etc. The example request summary provides information to the sales representative 125 and/or the quote generator circuitry 140 to enable modification and/or approval of the identified items, and/or generation of a quotation of the identified items.

In some examples, the order information provider circuitry 270 is instantiated by programmable circuitry executing order information provider instructions and/or configured to perform operations such as those represented by the flowchart(s) of FIGS. 9A, 9B, and 9C.

In some examples, the request interpreter circuitry 130 includes means for providing a request summary. For example, the means for providing a request summary may be implemented by order information provider circuitry 270. In some examples, the order information provider circuitry 270 may be instantiated by programmable circuitry such as the example programmable circuitry 1112 of FIG. 11. For instance, the order information provider circuitry 270 may be instantiated by the example microprocessor 1200 of FIG. 12 executing machine executable instructions such as those implemented by at least blocks 975 and 980 of FIGS. 9A, 9B, and 9C. In some examples, the order information provider circuitry 270 may be instantiated by hardware logic circuitry, which may be implemented by an ASIC, XPU, or the FPGA circuitry 1300 of FIG. 13 configured and/or structured to perform operations corresponding to the machine-readable instructions. Additionally or alternatively, the order information provider circuitry 270 may be instantiated by any other combination of hardware, software, and/or firmware. For example, the order information provider circuitry 270 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 3 is a diagram illustrating a flow of data through the request interpreter circuitry of FIGS. 1 and/or 2. In FIG. 3, a request 310 is received at the request management interface 210. Information 320 from the request 310 (e.g., a subject, a body, attachment, text, images, etc.) is extracted and provided to the item detection circuitry 230. The item detection circuitry 230 creates a table of items 330, which is analyzed by the type identifier circuitry 240 and the attribute detector circuitry 250 to generate attributes 340 for each item in the table of items. These attributes 340, along with customer information are utilized by the product identification circuitry 260 to generate a metal attributes SKU list 350, which is provided to the order information provider 270.

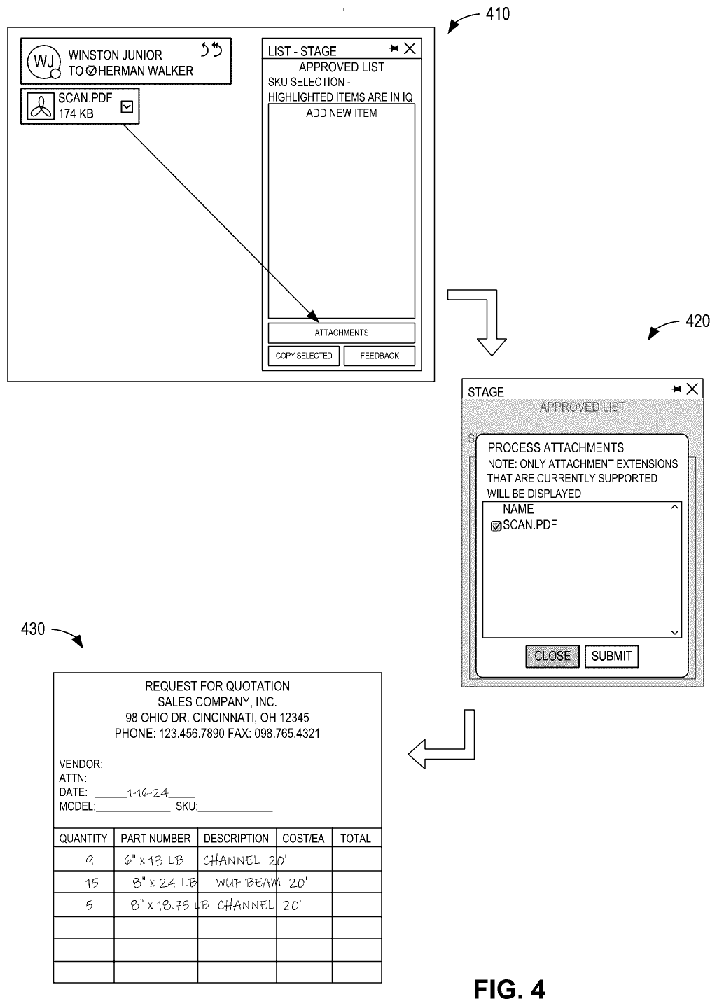

FIG. 4 is a diagram representing identification of an attachment to a request for quotation for processing. In the illustrated example of FIG. 4, a first user interface 410 is presented to the sales representative by the request management circuitry 120. The right column represents a plug-in or add-on to an email application, such as Outlook, and enables the sales representative to select attachments and/or messages to be provided to the request interpreter circuitry 130. A second user interface presents a dialog 420 that allows the sales representative to confirm which attachments are to be processed by the request interpreter circuitry 130. Such a dialog prevents inadvertent processing of data that is not intended for handling by the request interpreter circuitry 130. The request for quotation 430 of FIG. 4 represents a sample form that might be filled out by a customer and provided to a sales representative. Different forms may be used by different customers. Such different forms might have additional or fewer columns, include different amounts of contact information, etc. In some examples, the form is a hand-written form.

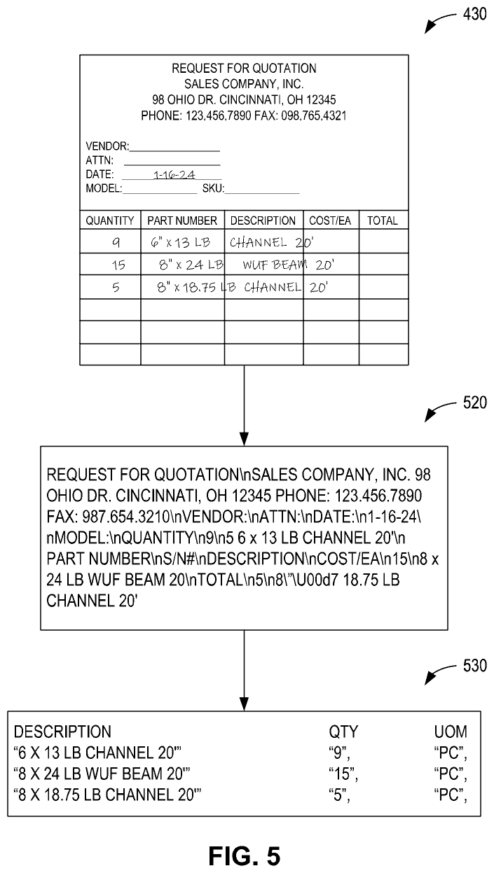

FIG. 5 is a diagram representing interpretation of the request for quotation 430 into a textual format. In some examples, when processing the request for quotation 430, the item detection circuitry 230 first identifies the text in an unstructured format 520. This format may include non-printing characters, such as characters that represent carriage returns, line breaks, etc. In some examples, other special characters may be identified as well. The example item detection circuitry 230 processes the unstructured text to generate structured data 530. In such an example, the example item detection circuitry 230 may execute (and/or cause execution of) a machine learning model to convert the unstructured text into the structured data. In some examples, this machine learning model may be a large language model trained to identify structured data within unstructured text.

FIG. 6A is a diagram representing different machine learning models that may be used to detect corresponding attributes of an item included in a request for quotation. These models help interpret complex customer requests and extract relevant information to generate accurate quotes. In some examples, only a few of the models illustrated in FIG. 6A are executed. Each of the models illustrated in FIG. 6A utilize at least the description of the item identified by the item detection circuitry 230 as an input. In some examples, other information, potentially including a result from the execution of other models are also used as an input to the model(s) of FIG. 6A.

A product detection model 610 identifies the name/group of the product mentioned in the customer's request, such as Carbon, Stainless, Aluminum, etc.

A form and shape detection model 620 detects the high-level physical form of the product, like sheet, coil, plate, bar, tube, structural, etc. The form and shape detection model 620 also detects the geometric shape of the metal, like round, hexagon, angle, channel, etc.

A grade detection model 630 identifies an industry designation for the grade of material used in the product, such as 304, 6061, 360, A36, etc.

A type detection model 640 detects other type attributes related to the form and shape of the product, like “Hot Rolled,” “Cold Rolled,” or “Galvanized.”

A dimension detection model 650 identifies numeric values that specify a measurement of each relevant physical size of the product. Such dimensions may include gauge, thickness, width, nominal length, diameter, inner/outer diameter, wall thickness, side dimensions, weight per unit, etc. Most commonly, the dimension is measured Imperial units (e.g., inches, feet, etc.), but sometimes other units of measurement are used, such as metric or industry unique scales, such as Gauge. In examples disclosed herein, because a customer might provide a wide range of requested dimensions, the dimension detection model 650 is implemented using a large language model, which is better suited for generatively producing a resulting dimension. In some examples, the dimension detection model 650 returns only those dimensions that were identified when analyzing the input request. For example, if the requested product having its dimensions analyzed were for sheet metal, the dimension detection model might not return an inner diameter or outer diameter, as those attributes are more suited for describing tubular forms.

A schedule detection model 655 detects unique dimensional characteristics for sizes of a pipe, which refers to its size and wall thickness combination, like Schedule 40, or Schedule 80.

A protection detection model 660 identifies materials that are applied to protect the metal in storage, transit, and/or processing, such as Paper Interleave, PVC film, cardboard tube, etc.

A pattern detection model 665 detects a physical attribute of the surface of the metal, usually embossed onto a sheet or plate, such as a medium pattern tread plate, etc.

An edge detection model 670 identifies any special processing to be applied to an edge of the metal such as, Mill Edge, Cut Edge, Round Edge, Square Edge, etc.

A finish detection model 675 detects additional processing that is to be applied to the surface of the metal, which may be required for certain end uses. Such example finishes might include, for example, #4, #8, 32RMS, etc.

A temper detection model 680 identifies additional processes to change the mechanical properties of the metal such as, Annealed, HSTR, H32, Full Hard, etc.

A hardness detection model 685 detects a desired hardness of the metal when mechanically tested, commonly using the Brinell or Rockwell scales. a desired hardness of the product, like “Rockwell HR-30T,” “Brinell 400 HB,” etc.

A coating detection model 690 identifies a desired coating that is permanently applied to the surface of the metal (usually to protect the surface). Example coatings may include, for example, G90, A60, T1-25, etc.

A surface treatment detection model 695 detects a desired surface treatment that may be applied to the product such as cleaning or something temporarily applied to the surface of the metal for protection such as LT OIL, CP, PO, etc.

In the illustrated example of FIG. 6A, the product detection model 610, the form and shape detection model 620, the grade detection model 630, the type detection model 640, the schedule detection model 655, the protection detection model 660, the pattern detection model 665, the edge detection model 670, the finish detection model 675, the temper detection model 680, the hardness detection model 685, the coating detection model 690, and the surface treatment detection model 695 are implemented as purpose-trained classifier models.

FIG. 6B is a diagram representing different machine learning models that may be used to detect corresponding attributes of an item included in a request for quotation. In contrast to the illustrated example of FIG. 6A, the example models of FIG. 6B are implemented as large language models. These models help interpret complex customer requests and extract relevant information to generate accurate quotes. Each of the models illustrated in FIG. 6B utilize at least the description of the item identified by the item detection circuitry 230 as an input, sometimes in connection with a prompt and/or other instructions to instruct the model to extract particular information. In some examples, other information, potentially including a result from the execution of other models (e.g., the models of FIG. 6A) are also used as an input to the model(s) of FIG. 6B.

A product hierarchy model 611 detects product hierarchy information including, for example, a name/group of a product, a form, and/or a shape. A dimension detection model 651 identifies dimensions such as gauge, thickness, width, nominal length, diameter, inner/outer diameter, wall thickness, side dimensions, weight per unit, a grade, and/or a type, etc. In contrast to the example dimension detection model 650 of FIG. 6A, the example dimension detection model 651 of FIG. 6B additionally detects the grade and the type of the product. In some examples, the dimension detection model 651 of FIG. 6B returns only those dimensions that were identified when analyzing the input request. For example, if the requested product having its dimensions analyzed were for sheet metal, the dimension detection model might not return an inner diameter or outer diameter, as those attributes are more suited for describing tubular forms.

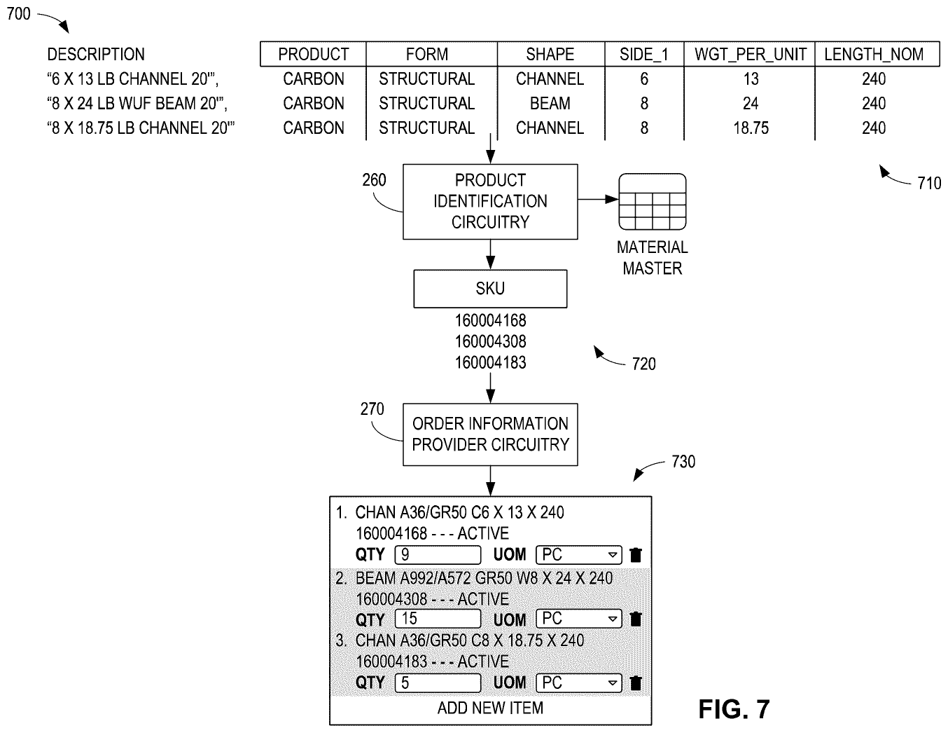

The example description attribute detection model 656 identifies information that would be otherwise detected by the models 655, 660, 665, 670, 675, 680, 685, 690, 695 of FIG. 6A. In other words, the description attribute detection model 656, when executed, causes identification of a schedule of the product, protection properties of the product, a desired pattern on the product, a desired edge profile of the product, a desired finish of the product, a desired temper of the product, a desired hardness of the product, a desired coating on the product, and a desired surface treatment of the product. FIG. 7 is a diagram 700 representing lookup of a stock keeping unit (SKU) based on detected attributes of an item identified in the request for quotation. A table of properties 710 (e.g., including those properties identified by the attribute detector circuitry 250 and/or the attribute detection model(s) 255) is provided as an input to the product identification circuitry 260, which consults information in the product database 135 to identify a specific product (e.g., by a SKU). 720. This SKU information is utilized by the order information provider circuitry 270 to generate the request summary 730.

In this manner, the SKU included in the request summary 730 represents the most likely SKU matching the customer's request, as identified by the request interpreter circuitry 130. However, there may be situations where a customer identifies a product that they did not initially intend, situations where an exact matching SKU might not be identified, etc. The sales representative 125 (having knowledge of the customer, the types of items the customer typically orders, the types of materials the customer typically needs, etc.) may review the request summary and make changes, if necessary. For example, the sales representative 125 may adjust the SKU, the quantity, and/or any other information identified by the request interpreter circuitry 130. In this manner, the request summary 730 also represents individual line items that a customer is requesting, which the request interpreter circuitry 130 lists in the same order that the customer requested.

In the illustrated example of FIG. 7, shading and/or other color coding is applied to some of the items in the request summary 720 to identify to the sales representative, for example, that there may have been modifications made to the identified product from the customer request (e.g., to replace a requested dimension with a dimension that can be supplied), that there may be limited supply of the identified items, that the customer may have ordered these items in the past, that the customer has not ordered this item in the past, etc. Different types of identifiers and/or visual representations may be used to identify such different types of alerts and/or warnings to the sales representative.

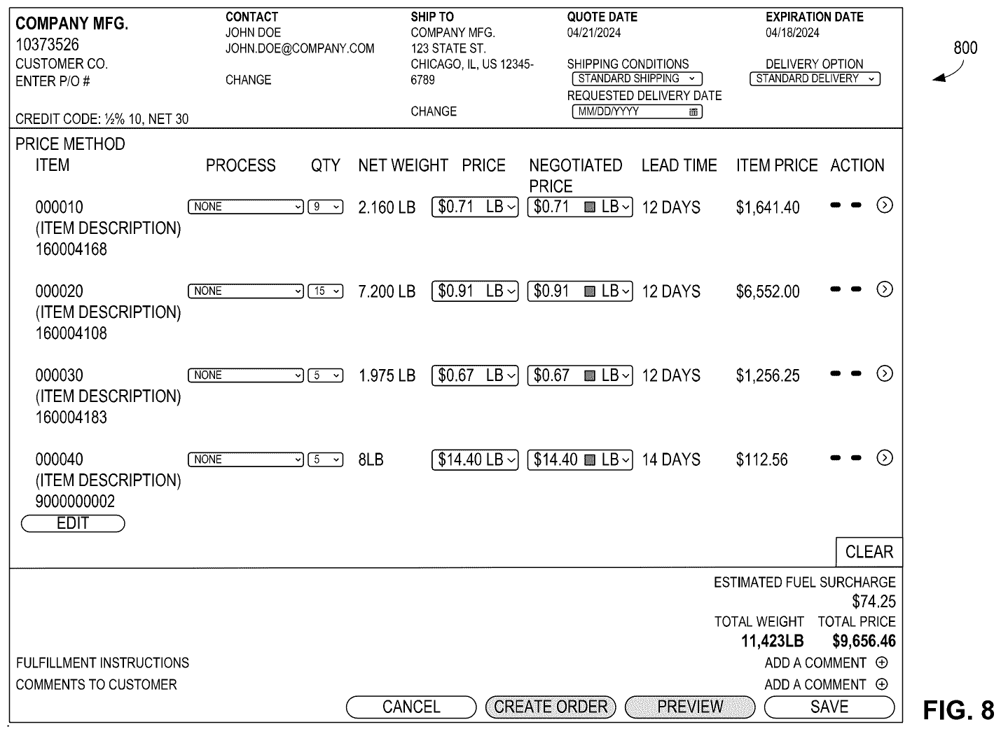

FIG. 8 is an example quotation review user interface 800 that may be presented to the sales representative. The example user interface includes information that would be included in a quotation that is to be provided to the customer. The example quotation review user interface 800 includes user interface elements (e.g., drop downs, selection buttons, etc.) that enable the sales representative 125 to make adjustments and/or changes to the quotation. In some examples, such changes and/or adjustments are reviewed by the example quotation generator circuitry 140 to determine whether such adjustments are allowed and/or require additional approval. For example, a reduction in price of an item to below a threshold price (e.g., which might have originated from a typographic error during selection and/or data entry), might cause a warning to be displayed to the sales representative. After reviewing the proposed quotation (and/or applying modifications, as desired), the sales representative may cause the quotation to be finalized and provided to the customer. In some examples, the quotation generator circuitry 140 may cause the quote to be sent (e.g., emailed) to the customer. Additionally or alternatively, the quotation may be provided to the sales representative 125 to enable the sales representative 125 to provide the quotation to the customer. In some other examples, quotations may be accessible to the customer via a web-based user interface provided by the quotation generator circuitry 140. For example, the quotation may be associated with a customer account, and be visible when logged in to that customer account.

While an example manner of implementing the supplier infrastructure 118 of FIG. 1 is illustrated in FIG. 1, one or more of the elements, processes, and/or devices illustrated in FIG. 1 may be combined, divided, re-arranged, omitted, eliminated, and/or implemented in any other way. Further, the item detection circuitry 230, the quotation generator circuitry 240, and/or, more generally, the example supplier infrastructure 118 of FIG. 1, may be implemented by hardware alone or by hardware in combination with software and/or firmware. Thus, for example, any of the item detection circuitry 230, the quotation generator circuitry 240, and/or, more generally, the example supplier infrastructure 118, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example supplier infrastructure 118 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the supplier infrastructure 118 of FIG. 1 and/or representative of example operations which may be performed by programmable circuitry to implement and/or instantiate the supplier infrastructure 118 of FIG. 1, are shown in FIGS. 9A, 9B, 9C, and/or 10. The machine readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 9A, 9B, 9C, and/or 10, many other methods of implementing the example supplier infrastructure 118 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 9A, 9B, 9C, and/or 10 may be implemented using executable instructions (e.g., computer readable and/or machine-readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIGS. 9A, 9B, and 9C are a flowchart representative of example machine readable instructions and/or example operations 900 that may be executed, instantiated, and/or performed by programmable circuitry to interpret a request for quotation and prepare a request summary based thereon. The example machine-readable instructions and/or the example operations 900 of FIGS. 9A, 9B, and 9C begin at block 910 of FIG. 9A, at which the email database interface 220 and/or the request management interface 210 accesses an email or attachment requesting a quote. (Block 910). In some examples, the request management interface 210 may begin processing the email and/or attachment requesting the quote based on the email and/or attachment having been tagged (e.g., by the request management circuitry 120 and/or the sales representative 125). Such tagging may represent that the email and/or attachment represents a request for a quote, as opposed to an email or other communication that does not request a quote. To that end, the example request management interface 210 may periodically and/or a-periodically search for tagged communications that have not yet been processed by the request interpreter circuitry 130.

The example item detection circuitry 230 itemizes the request into a table of items. (Block 920). This table of items (e.g., the table of items 330 of FIG. 3) helps organize and/or manage the request when multiple items are requested in a single request. In examples disclosed herein, optical character recognition (OCR) and/or other form recognition techniques are utilized to convert an input request (e.g., an email message, an image of a handwritten request form, etc.) into a parseable format. The example item detection circuitry 230 may then convert the parseable format (e.g., the text 520 of FIG. 5) into a tabular data structure (e.g., the table 530 of FIG. 3). Of course, any other type of data structure may additionally or alternatively be used.

The item detection circuitry 230 then selects an item from the table for processing (Block 930). The selected item will then have its attributes determined. In the illustrated example of FIG. 9A, the attribute determination is performed using two approaches: detection of attributes using one or more specialty model(s) (block 931, described further in FIG. 9B), and detection of attributes using generative model(s) (block 932, described further in FIG. 9C). In some examples, only one of such approaches might be utilized. As will be described below, upon completion of the attribute detection using each approach, the resulting attributes for the item are assembled.

The illustrated example of FIG. 9B represents the detection of attributes using one or more specialty model(s). (Block 931). In the illustrated example of FIG. 9B, the type identifier circuitry 240 executes (and/or causes execution of) a machine learning model to identify a form and/or a shape of the item. (Block 935). In examples disclosed herein, detecting the form and/or the shape of the item is important as different forms/shapes of items may have different properties that enable accurate lookup of the product. In examples disclosed herein, a form and shape model (e.g., the form and shape model 620 of FIG. 6A) is utilized to determine the form and/or the shape of the requested item. However, other properties may additionally or alternatively be included in the determination of the form/shape of the item.

Based on the detected form/shape of the item, the type identifier circuitry 240 determines which attributes are needed to accurately identify a stock keeping unit (SKU) for that particular item. In some examples, this may be referred to as a list of relevant attributes. For example, if the form/shape of the item represents sheet metal goods, attributes such as a grade, type, dimensions, finish, pattern, coating, edge, and surface treatment may be included in the list of relevant attributes for accurately identifying a SKU for the item. In such an example, certain attributes, such as a schedule, an inner diameter, an outer diameter, are not applicable and need not be included in the list of relevant attributes to accurately identify the SKU of the item. In contrast, if the form/shape of the item represents tubular metal goods, different attributes may be included and/or omitted from the list of relevant attributes. Various combinations of such attributes might be identified based on the form/type of the item.

The example attribute detector circuitry 250 selects an attribute to be identified from the list of relevant attributes. (Block 945). The example attribute detector circuitry 250 identifies a corresponding machine learning model (e.g., of the attribute detection models 255) to be utilized to detect a value of the identified attribute, and executes the corresponding model to identify a value for the selected attribute. (Block 950). As explained in connection with FIG. 6A, different models and/or types of models may be trained to detect particular attributes from a description. For example, if a schedule attribute is to be identified, the schedule detection model 655 may be executed to produce an output identifying a value to be used for the schedule attribute. In examples disclosed herein, the line item description (e.g., the description of the item appearing in table 530 of FIG. 5) is provided as an input to the corresponding model. However, in some examples, additional inputs may be provided to the model including, for example, information about past customer orders, identifications of other attributes to be detected (and/or values for those attributes that had already been detected). The example attribute detector circuitry 250 determines whether there are any additional attribute(s) to be detected (e.g., based on the list of relevant attributes). (Block 955). If additional attributes are to be detected (e.g., block 955 returns a result of YES), the example process of blocks 945, 950, 955 continues until no additional relevant attributes exist for identification.

Once all relevant attributes have been identified, the example attribute detector circuitry 250 returns the detected attributes. (Block 956). Control then returns to block 958 of FIG. 9A, where the results of the detection of attributes using the specialty model(s) (block 931) are combined with results of the detection of attributes using generative models (block 932).

The illustrated example of FIG. 9C represents the detection of attributes using one or more generative model(s). (Block 932). In the illustrated example of FIG. 9C, the example attribute detector circuitry 250 executes (or causes execution of) a product hierarchy model (e.g., the product hierarchy model 611 of FIG. 6B) to detect attributes that are used to generally identify the product (e.g., a product name/group, a form, a shape, etc.). (Block 941). In this manner, the description of the item may be combined with a prompt instructing the attribute detector circuitry 250 regarding identification of the product name/group, form, and/or shape.

The example attribute detector circuitry 250 executes (or causes execution of) a dimension detection model (e.g., the dimension detection model 651 of FIG. 6B) to detect attributes that identify a dimension of a product. (Block 942). Execution of the dimension detection model 651 causes identification of one or more dimensions including gauge, thickness, width, nominal length, diameter, inner/outer diameter, wall thickness, side dimensions, weight per unit, a grade, and/or a type, etc.

The example attribute detector circuitry 250 executes (or causes execution of) a description attribute detection model (e.g., the description attribute detection model 656 of FIG. 6B) to detect descriptive attributes for the product. (Block 943). Execution of the description attribute detection model 656 causes identification of one or more of a schedule of the product, protection properties of the product, a desired pattern on the product, a desired edge profile of the product, a desired finish of the product, a desired temper of the product, a desired hardness of the product, a desired coating on the product, a desired surface treatment of the product, etc. Of course, other properties and/or attributes may additionally or alternatively be identified.

The attributes identified by the execution of the product hierarchy model, the dimension detection model, and the description attribute detection model are then returned. (Block 957). Control then returns to block 958 of FIG. 9A, where the results of the detection of attributes using the specialty model(s) (block 931) are combined with results of the detection of attributes using generative models (block 932).

Returning to FIG. 9A, the example attribute detector circuitry 250 assembles the attributes detected by the specialty model(s) and the generative model(s) for the item. (Block 958). In some examples, preference is given to the attributes detected using the generative model(s) (when identified and/or valid). In other words, if an attribute is identified by both the specialty model(s) and the generative model(s), the attribute from the generative model(s) is used in the assembled attributes. In some other examples, preference may be given to attributes identified by the specialty model(s). In some examples, confidence values might additionally be produced by the specialty model(s) and/or the generative model(s) and be used for selection of which detected attribute is to be used in the assembled attributes.

The example product identification circuitry 260 identifies a product (e.g., a SKU) based on the assembled attributes. (Block 960). In examples disclosed herein, the example product identification circuitry 260 constructs a query (e.g., a structured query language (SQL) query) to a be executed at the product database based on the identified attributes. In some examples, different formats of queries might be used based on the form/shape, the list of relevant attributes, etc.

The example type identifier circuitry 240 then determines if any additional items exist in the table for identification. (Block 970). If additional items exist for identification, control returns to block 935, where the process of blocks 935 through 970 is repeated until all items have been individually identified and/or processed.

After completing attribute identification and product recognition, the order information provider circuitry 270 prepares a request summary. (Block 975). The request summary includes information including, for example, the identified SKU of each item, the quantity of each item, the unit of measure for each item, etc. In some examples, additional information is included in the request including, for example, an identifier of the customer and/or other customer information (e.g., a customer email address, a customer shipping address, etc.). Such a request summary may be formatted in any data structure including for example, extensible markup language (XML), JavaScript object notation (JSON), etc.

The request summary is then provided to either the request management circuitry or quotation generator circuitry by the order information provider circuitry 270. (Block 980). If, for example, the request summary is provided to the request management circuitry, the representative 125 may review and/or modify the request summary prior to the generation of a quotation by the quotation generator circuitry 140. Alternatively, the representative 125 might also make modifications to the quotation directly using the quotation generation circuitry 140.

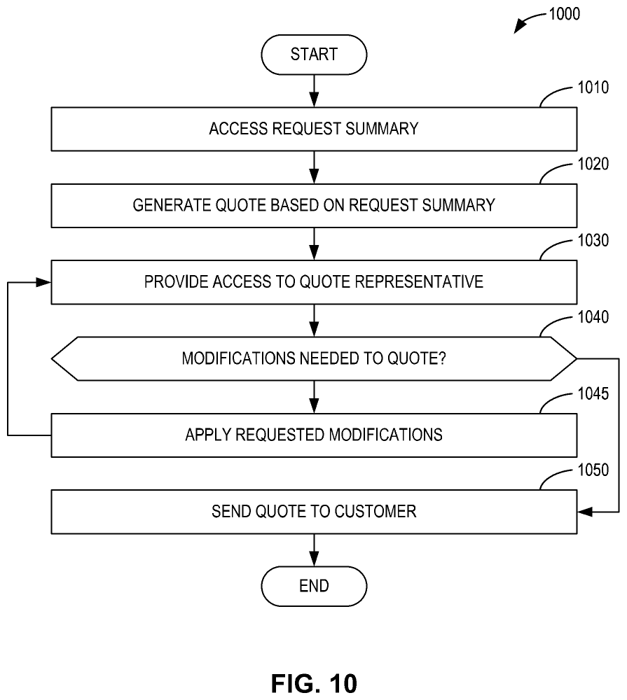

FIG. 10 is a flowchart representative of example machine readable instructions and/or example operations that may be executed, instantiated, and/or performed by example programmable circuitry to implement the quotation generator circuitry 140 of FIG. 1 to prepare a quotation based on the request summary. The example process 1000 of FIG. 10 begins when the example quotation generator circuitry 140 accesses a request summary. (Block 1010). The request summary may be accessed (e.g., received) from the request management circuitry 120. In some examples, the request summary is provided directly to the quotation generator circuitry 140 by the request interpreter circuitry 130. In examples disclosed herein, the request summary is formatted in a data structure that is parseable by the quotation generator circuitry 140 such as, for example, extensible markup language (XML), JavaScript object notation (JSON), comma separated values (CSV), etc.

The example quotation generator circuitry 140 generates a quote based on the request summary. (Block 1020). In other words, using the SKU information provided in the request summary that was identified by the request interpreter circuitry 130, the example quotation generator circuitry 140 can create an accurate quote without the need for a sales representative to review and identify SKU information for items requested by a customer. In some examples, this quotation is based on additional information such as, for example, an identification of the customer, the location of the customer, etc. In this manner, the quotation generator circuitry 140 may consider existing sales relationships with the customer (e.g., agreed-upon discounts, required lead times for delivery, etc.) when preparing the quotation.

Once the quotation has been generated, access to the quotation is provided to the representative 125. (Block 1030). The representative may then review and/or modify the quotation as needed. If modifications are needed (e.g., block 1040 returns a result of YES), the example quotation generator circuitry 140 applies the requested modifications to the quotation. (Block 1045). The sales representative 125 may then continue to review and/or modify the quotation until they are satisfied that the quotation is ready to be provided to the customer. (e.g., until block 1040 returns a result of NO). The example quotation generator circuitry 140 may then provide the quotation to the customer. (Block 1050). This may be achieved using an email address of the customer and/or other approaches for contacting the customer. In some examples, the quotation may be provided to the sales associate 125 by the quotation generator circuitry 140 such that the sales associate may then provide the quotation to the customer (e.g., in response to the initial request for quotation.). In some examples, rather than providing the quote to the customer, an order may be placed on behalf of the customer (e.g., without providing the quotation to the customer for further review). Such order placement may be performed based on the review provided by the sales representative 125.

FIG. 11 is a block diagram of an example programmable circuitry platform 1100 structured to execute and/or instantiate the example machine-readable instructions and/or the example operations of FIGS. 9A, 9B, 9C, and/or 10 to implement the supplier infrastructure 118 of FIG. 1. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example request interpreter circuitry 130 and/or the example quotation generator circuitry 140.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 9A, 9B, 9C, and/or 10, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 9A, 9B, 9C, and/or 10 to effectively instantiate the circuitry of FIG. 2 as logic circuits to perform operations corresponding to those machine-readable instructions. In some such examples, the circuitry of FIG. 1 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine-readable instructions and/or operations represented by the flowcharts of FIGS. 9A, 9B, 9C, and/or 10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer-based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and

FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine-readable instructions. However, once configured, the FPGA circuitry 1300 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart(s) of FIGS. 9A, 9B, 9C, and/or 10 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 9A, 9B, 9C, and/or 10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9A, 9B, 9C, and/or 10. As such, the FPGA circuitry 1300 may be configured and/or structured to effectively instantiate some or all of the operations/functions corresponding to the machine readable instructions of the flowchart(s) of FIGS. 9A, 9B, 9C, and/or 10 as dedicated logic circuits to perform the operations/functions corresponding to those software instructions in a dedicated manner analogous to an ASIC. Therefore, the FPGA circuitry 1300 may perform the operations/functions corresponding to the some or all of the machine-readable instructions of FIGS. 9A, 9B, 9C, and/or 10 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine-readable instructions of FIGS. 9A, 9B, 9C, and/or 10 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIGS. 9A, 9B, 9C, and/or 10 to perform first operation(s)/function(s), the FPGA circuitry 1300 of FIG. 13 may be configured and/or structured to perform second operation(s)/function(s) corresponding to a second portion of the machine readable instructions represented by the flowcharts of FIGS. 9A, 9B, and 9C and/or 10, and/or an ASIC may be configured and/or structured to perform third operation(s)/function(s) corresponding to a third portion of the machine readable instructions represented by the flowcharts of FIGS. 9A, 9B, 9C, and/or 10.

It should be understood that some or all of the circuitry of FIG. 1 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 1 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

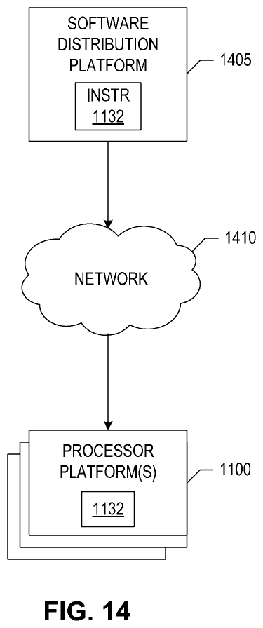

A block diagram illustrating an example software distribution platform 1405 to distribute software such as the example machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine-readable instructions 1132, which may correspond to the example machine readable instructions of FIGS. 9A, 9B, 9C, and/or 10, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1132 from the software distribution platform 1405. For example, the software, which may correspond to the example machine readable instructions of FIGS. 9A, 9B, and 9C and/or 10, may be downloaded to the example programmable circuitry platform 1100, which is to execute the machine readable instructions 1132 to implement the request interpreter circuitry 130. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to methods and apparatus to provide a quotation for metal using machine learning model(s) are disclosed herein. Further examples and combinations thereof include the following:

Example 1 includes at least one non-transitory machine readable storage medium comprising instructions to cause programmable circuitry to at least access a request from a customer for a quotation, create a data structure identifying at least one item included in the request, use a machine learning model to identify at least one attribute of the at least one item based on the data structure, select a product identifier based on the at least one attribute, generate a request summary using the product identifier, and prepare the quotation to be provided to the customer.

Example 2 includes the at least one non-transitory machine-readable storage medium of example 1, wherein the at least one item included in the request for the quotation is a metal product.

Example 3 includes the at least one non-transitory machine-readable storage medium of example 2, wherein the at least one attribute is a desired schedule of the item, a desired edge profile of the product, a desired finish of the product, or a desired temper of the product.

Example 4 includes the apparatus of any one or more of examples 1-3, wherein the machine learning model is a classifier model trained to detect the at least one attribute.

Example 5 includes the at least one non-transitory machine readable storage medium of example 4, wherein the machine learning model is a first machine learning model, and the instructions cause the programmable circuitry to use a second machine learning model to identify the at least one attribute of the at least one item based on the data structure, the second machine learning model being a generative model.

Example 6 includes the at least one non-transitory machine-readable storage medium of example 5, wherein the instructions cause the programmable circuitry to select the at least one attribute identified by the second machine learning model for use in the selection of the product identifier based on the at least one attribute.

Example 7 includes the at least one non-transitory machine-readable storage medium of example 1, wherein the machine learning model is a first machine learning model, and the instructions cause the programmable circuitry to identify a type of the product based on the data structure, determine a list of attributes based on the type of the product, use the first machine learning model to identify a first attribute in the list of attributes, and use a second machine learning model to identify a second attribute in the list of attributes, the selection of the product identifier based on the type of the product, the first attribute, and the second attribute.

Example 8 includes the apparatus of any one or more of examples 1-7, wherein the data structure includes a description of the item as provided in the request for the quotation.

Example 9 includes an apparatus to provide a quotation for metal, the apparatus comprising interface circuitry, machine-readable instructions, and programmable circuitry to at least one of instantiate or execute the machine readable instructions to access a request from a customer for a quotation, create a data structure identifying at least one item included in the request, use a machine learning model to identify at least one attribute of the at least one item based on the data structure, select a product identifier based on the at least one attribute, generate a request summary using the product identifier, and prepare the quotation to be provided to the customer.

Example 10 includes the apparatus of example 9, wherein the at least one item included in the request for the quotation is a metal product.

Example 11 includes the apparatus of example 10, wherein the at least one attribute is a desired schedule of the item, a desired edge profile of the product, a desired finish of the product, or a desired temper of the product.

Example 12 includes the apparatus of any one or more of examples 9-11, wherein the machine learning model is a classifier model trained to detect the at least one attribute.

Example 13 includes the apparatus of example 12, wherein the machine learning model is a first machine learning model, and the instructions cause the programmable circuitry to use a second machine learning model to identify the at least one attribute of the at least one item based on the data structure, the second machine learning model being a generative model.

Example 14 includes the apparatus of example 13, wherein the instructions cause the programmable circuitry to select the at least one attribute identified by the second machine learning model for use in the selection of the product identifier based on the at least one attribute.

Example 15 includes the apparatus of any one or more of examples 9-14, wherein the machine learning model is a first machine learning model, and the instructions cause the programmable circuitry to identify a type of the product based on the data structure, determine a list of attributes based on the type of the product, use the first machine learning model to identify a first attribute in the list of attributes, and use a second machine learning model to identify a second attribute in the list of attributes, the selection of the product identifier based on the type of the product, the first attribute, and the second attribute.

Example 16 includes the apparatus of any one or more of examples 9-15, wherein the data structure includes a description of the item as provided in the request for the quotation.

Example 17 includes a method for providing a quotation for metal, the method comprising accessing a request from a customer for a quotation, creating a data structure identifying at least one item included in the request, using a machine learning model to identify at least one attribute of the at least one item based on the data structure, selecting a product identifier based on the at least one attribute, generating a request summary using the product identifier, and preparing the quotation to be provided to the customer.

Example 18 includes the method of example 17, wherein the at least one item included in the request for the quotation is a metal product.

Example 19 includes the method of example 18, wherein the at least one attribute is a desired schedule of the item, a desired edge profile of the product, a desired finish of the product, or a desired temper of the product.

Example 20 includes the method of any one or more of examples 17-19, wherein the machine learning model is a classifier model trained to detect the at least one attribute.

Example 21 includes the method of example 20, wherein the machine learning model is a first machine learning model, and the method further includes using a second machine learning model to identify the at least one attribute of the at least one item based on the data structure, the second machine learning model being a generative model.

Example 22 includes the method of example 21, further including selecting the at least one attribute identified by the second machine learning model for use in the selection of the product identifier based on the at least one attribute.

Example 23 includes the method of any one or more of examples 17-22, wherein the machine learning model is a first machine learning model, the method further including identifying a type of the product based on the data structure, determining a list of attributes based on the type of the product, using the first machine learning model to identify a first attribute in the list of attributes, and using a second machine learning model to identify a second attribute in the list of attributes, the selection of the product identifier based on the type of the product, the first attribute, and the second attribute.

Example 24 includes the method of any one or more of examples 17-23, wherein the data structure includes a description of the item as provided in the request for the quotation.

From the foregoing, it will be appreciated that example systems, apparatus, articles of manufacture, and methods have been disclosed that enable efficient and timely replies to customer inquiries. By utilizing machine learning techniques to interpret customer requests, sales representatives 125 are freed to perform additional customer-facing tasks and provide better service to their customers. Likewise, the computing systems operated by such sales representatives 125 are also made more efficient, as less compute resources are utilized by the sales representative 125 to perform lookups of product information. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory machine-readable storage medium comprising instructions to cause programmable circuitry to at least:
access a request from a customer for a quotation;
create a data structure identifying at least one item included in the request;
use a machine learning model to identify at least one attribute of the at least one item based on the data structure;
select a product identifier based on the at least one attribute;
generate a request summary using the product identifier; and
prepare the quotation to be provided to the customer.

2. The at least one non-transitory machine-readable storage medium of claim 1, wherein the at least one item included in the request for the quotation is a metal product.

3. The at least one non-transitory machine-readable storage medium of claim 2, wherein the at least one attribute is a desired schedule of the item, a desired edge profile of the product, a desired finish of the product, or a desired temper of the product.

4. The at least one non-transitory machine-readable storage medium of claim 1, wherein the machine learning model is a classifier model trained to detect the at least one attribute.

5. The at least one non-transitory machine-readable storage medium of claim 4, wherein the machine learning model is a first machine learning model, and the instructions cause the programmable circuitry to:
use a second machine learning model to identify the at least one attribute of the at least one item based on the data structure, the second machine learning model being a generative model.

6. The at least one non-transitory machine-readable storage medium of claim 5, wherein the instructions cause the programmable circuitry to select the at least one attribute identified by the second machine learning model for use in the selection of the product identifier based on the at least one attribute.

7. The at least one non-transitory machine-readable storage medium of claim 1, wherein the machine learning model is a first machine learning model, and the instructions cause the programmable circuitry to:
identify a type of the product based on the data structure;
determine a list of attributes based on the type of the product;
use the first machine learning model to identify a first attribute in the list of attributes; and
use a second machine learning model to identify a second attribute in the list of attributes, the selection of the product identifier based on the type of the product, the first attribute, and the second attribute.

8. The at least one non-transitory machine-readable storage medium of claim 1, wherein the data structure includes a description of the item as provided in the request for the quotation.

9. An apparatus to provide a quotation for metal, the apparatus comprising:
interface circuitry;
machine-readable instructions; and
programmable circuitry to at least one of instantiate or execute the machine-readable instructions to:
access a request from a customer for a quotation;
create a data structure identifying at least one item included in the request;
use a machine learning model to identify at least one attribute of the at least one item based on the data structure;
select a product identifier based on the at least one attribute;
generate a request summary using the product identifier; and
prepare the quotation to be provided to the customer.

10. The apparatus of claim 9, wherein the at least one item included in the request for the quotation is a metal product.

11. The apparatus of claim 10, wherein the at least one attribute is a desired schedule of the item, a desired edge profile of the product, a desired finish of the product, or a desired temper of the product.

12. The apparatus of claim 9, wherein the machine learning model is a classifier model trained to detect the at least one attribute.

13. The apparatus of claim 12, wherein the machine learning model is a first machine learning model, and the instructions cause the programmable circuitry to:
use a second machine learning model to identify the at least one attribute of the at least one item based on the data structure, the second machine learning model being a generative model.

14. The apparatus of claim 13, wherein the instructions cause the programmable circuitry to select the at least one attribute identified by the second machine learning model for use in the selection of the product identifier based on the at least one attribute.

15. The apparatus of claim 9, wherein the machine learning model is a first machine learning model, and the instructions cause the programmable circuitry to:
identify a type of the product based on the data structure;
determine a list of attributes based on the type of the product;
use the first machine learning model to identify a first attribute in the list of attributes; and
use a second machine learning model to identify a second attribute in the list of attributes, the selection of the product identifier based on the type of the product, the first attribute, and the second attribute.

16. The apparatus of claim 9, wherein the data structure includes a description of the item as provided in the request for the quotation.

17. A method for providing a quotation for metal, the method comprising
accessing a request from a customer for a quotation;
creating a data structure identifying at least one item included in the request;
using a machine learning model to identify at least one attribute of the at least one item based on the data structure;
selecting a product identifier based on the at least one attribute;
generating a request summary using the product identifier; and
preparing the quotation to be provided to the customer.

18. The method of claim 17, wherein the at least one item included in the request for the quotation is a metal product.

19. The method of claim 18, wherein the at least one attribute is a desired schedule of the item, a desired edge profile of the product, a desired finish of the product, or a desired temper of the product.

20. The method of claim 17, wherein the machine learning model is a classifier model trained to detect the at least one attribute.
